(19) United States
(12) Patent Application Publication
(10) Pub. No.: US 2004/0089026 A1
(43) Pub. Date: May 13, 2004

(54) Precursor and method of growing doped glass films

(76) Inventors: Robert A. Bellman, Painted Post, NY (US); Steven B. Dawes, Corning, NY (US); Lynn B. Simpson, Painted Post, NY (US); Ljerka Ukrainczyk, Painted Post, NY (US)

Correspondence Address: CORNING INCORPORATED, SP-TI-3-1, CORNING, NY, 14831

(21) Appl. No.: 10/608,580

(22) Filed: Jun. 27, 2003

Related U.S. Application Data
(62) Division of application No. 10/000,814, filed on Nov. 30, 2001, now abandoned.

(51) Int. Cl. C03B 37/018

(52) U.S. Cl. 65/413

(57) ABSTRACT

The present invention includes a method of growing a doped glass films suitable for optical applications on a substrate comprising the steps of conveying an organometallic compound of the formula (R₃SiO)ⱼM(OR′)ₖ to the substrate and reacting the silica forming substance and the organometallic compound to form the optical layer on the substrate, where M is a metal; R is methyl, ethyl or propyl; R′ is methyl, ethyl, n-propyl, n-butyl, isobutyl or s-butyl; j is 1, 2, 3 or 4; and k=4−j. The present invention also includes planar optical devices made by the above method. Additionally, the present invention includes an optical fiber made by the above method.

### BACKGROUND OF THE INVENTION

A. Field of the Invention

The invention relates generally to the deposition of thin films and, more particularly, to a method of depositing doped glass films suitable for photonic devices.

B. Description of the Related Art

Many important optical devices are fabricated from thin films of differing refractive indices. Examples include, but are not limited to, planar photonic devices, optical fibers, thin film interference filters and antireflective coatings. These devices have different structures and different functions but all require precise control of the refractive indices of the thin films. Typically, the refractive indices of these devices must be controlled to within about 0.001. This is especially true for planar photonic devices such as planar waveguides.

Planar photonic devices include a high index waveguide core buried in a low index cladding material, which may be supported by a substrate. Silica based glasses are useful materials for forming the waveguide. These glasses can be deposited by flame hydrolysis deposition (FHD), chemical vapor deposition (CVD), plasma enhanced chemical vapor deposition (PECVD), and various physical vapor deposition methods including sputtering and e-beam deposition. FHD and PECVD are favored for the deposition of silica based glass waveguides because of their high growth rates and the low propagation losses of the deposited materials.

For a planar waveguide, the difference in refractive index (Δn) between the core and cladding should be small, typically less than 1%. Further, in order to fabricate a high quality device, the core and cladding refractive indices must be uniform and consistent along the length of the waveguide. To achieve the refractive index difference, the core material is most often doped with oxides of germanium or phosphorus or with nitrogen. For significant index changes, high levels of dopant are necessary, which impacts other properties of the material such as coefficient of thermal expansion and glass transition temperature. Further, a device with a uniform and consistent Δn is only possible if the amount and distribution of the dopant material is controlled precisely. This entails precisely controlling the introduction of the silica and dopant precursors in the deposition process.

In conventional deposition processes, individual silica and dopant precursors are introduced and reacted to form the layers of the photonic device. These precursors may be either gaseous or liquid. Gaseous precursor materials are typically introduced into the process by mass flow controllers while liquid precursor materials are introduced by bubblers, vapor phase mass flow controllers, or flash evaporators. Because the accuracy and reproducibility of the various precursor control devices is typically 0.1 to 1%, it is difficult to consistently control the doping concentration in the growing planar optical device.

In addition to the problem of controlling the dopant concentration, the use of multiple precursors exacerbates two additional problems which may significantly degrade the performance of the device. First, dopant atoms may cluster together rather than distribute evenly, creating a detrimental local variation in index. Second, subsequent heat treatment of a film containing such clusters of dopant metal-oxygen-metal bonds results in formation of crystallites which create local variations in refractive index as well as cause scattering loss.

Clustering is especially problematic with conventional Ti and Zr precursors, such as Ti(OEt)₄, TiCl₄, Zr(OEt)₄, and ZrCl₄. These precursors are much more reactive than silicon precursors and tend to self-react to form clusters. Additionally, these precursors tend to react prematurely, polymerizing in the apparatus if conditions are not kept rigorously dry.

Therefore, it would be advantageous to have a fabrication method and precursor which reliably produces the desired doping profile and reduces the likelihood of clustering and crystallization of dopant in a photonic device.

### SUMMARY OF THE INVENTION

The present invention includes a method of growing a doped glass layer suitable for optical applications on a substrate comprising reacting an organometallic compound of the formula (R₃SiO)ⱼM(OR′)ₖ to form a layer of doped silica on the surface, wherein M is Ti or Zr; R is an alkyl moiety; R′ is an alkyl moiety; j is 1, 2, 3 or 4; and k=4−j.

The present invention also includes a planar optical device made using the above method.

Additionally, the present invention includes an optical fiber preform made using the above method.

### BRIEF DESCRIPTION OF THE DRAWINGS

The foregoing and other features, aspects and advantages of the present invention will become apparent from the following description, appended claims and the exemplary embodiments shown in the drawings, which are briefly described below.

FIG. 1 is a schematic plot of refractive index as a function of dopant concentration.

FIG. 2 is a schematic plot of dopant concentration as a function of dopant precursor flow rate.

FIG. 3 is a plot of refractive index versus dopant precursor flow rate.

FIG. 4 is a plot illustrating the effect of slope on the variation on the index of refraction.

FIG. 5 is an FTIR spectrum of a doped silica film deposited from tetrakis(trimethylsiloxy)titanium.

FIG. 6 is an XRD pattern of a doped silica film having 20 mol % TiO₂ deposited from tetrakis(trimethylsiloxy)titanium and annealed in air at 1000° C. for 18 h.

FIG. 7 is an FTIR spectrum showing three doped silica films with different titanium oxide concentrations deposited from (trimethylsiloxy)triisopropoxytitanium.

### DETAILED DESCRIPTION OF SPECIFIC EMBODIMENTS

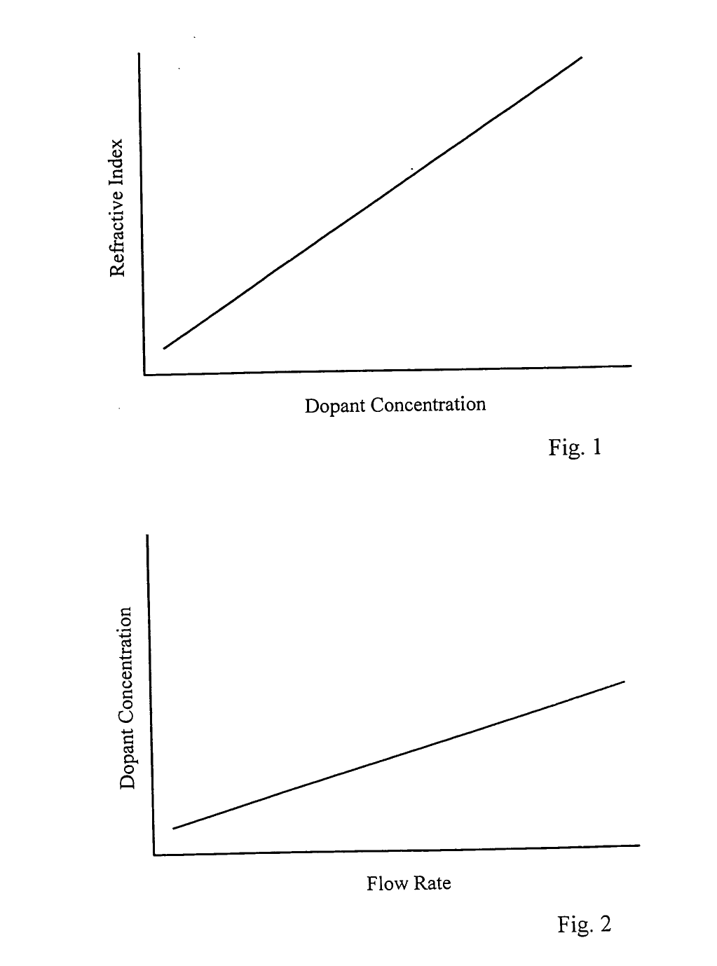

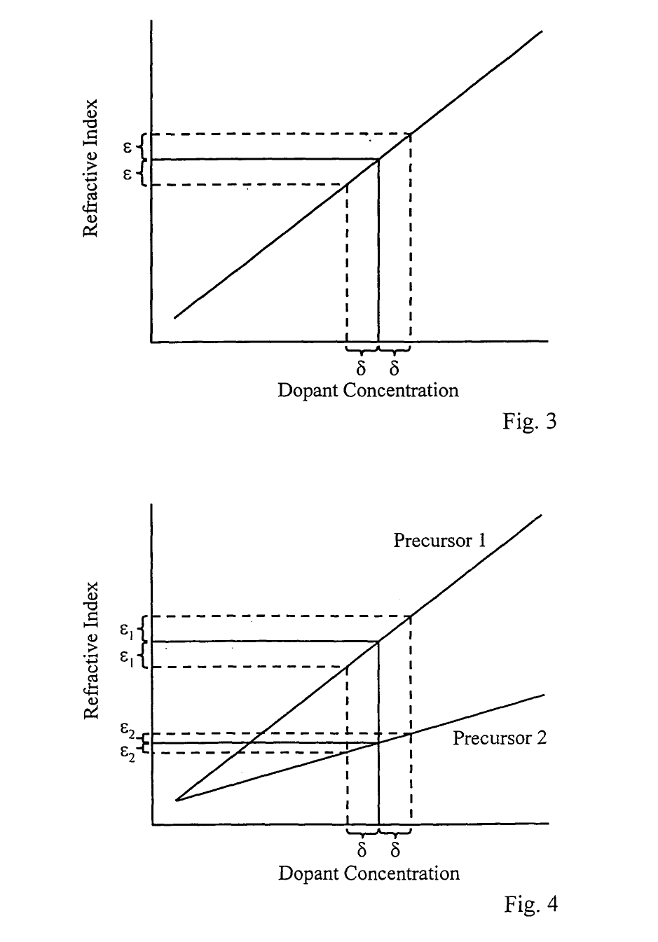

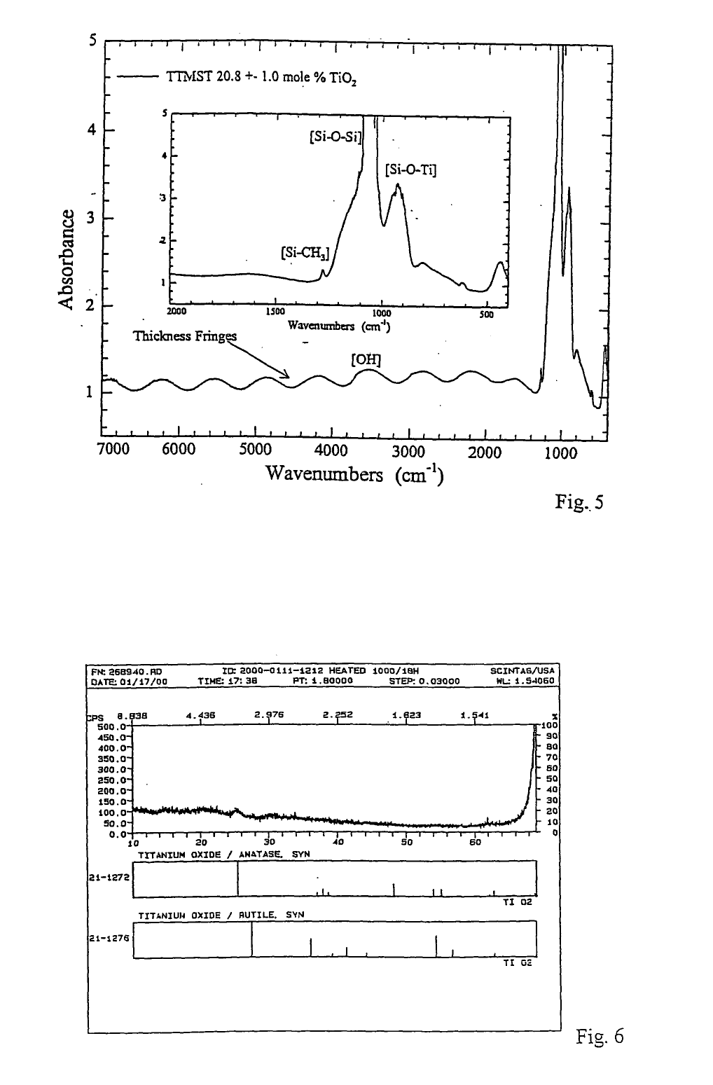

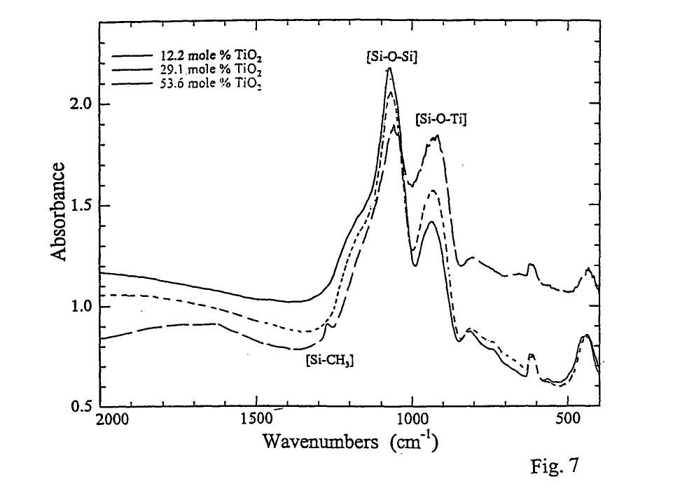

In the present invention, a dopant atom M is introduced into a glass material by using a dopant precursor compound in the deposition process. It is difficult to control the index of refraction in the growing glass layer unless the slope of the index versus dopant precursor concentration is gentle. This is illustrated in FIGS. 1-4. FIG. 1 schematically illustrates the increase of the index of refraction as a function of dopant concentration while FIG. 2 illustrates the increase in the dopant concentration as a function of the dopant precursor flow rate. Because the dopant concentration increases with dopant precursor flow rate and the refractive index increases with dopant concentration, the refractive index must increase with an increase in the dopant precursor flow rate. This is illustrated in FIG. 3. Also illustrated in FIG. 3 is the effect of the variation in the refractive index due to the variation in dopant precursor flow rate introduced by a typical flow control device. For a given variation in flow rate δ, the index of refraction varies as ε. Hence, for a given flow controller, the variation in index can be reduced by using a dopant precursor whose effect on the index of refraction is less sensitive to the flow rate. This is illustrated in FIG. 4. Precursor 2 has a gentler slope than precursor 1, resulting in a smaller variation in index of refraction ε₂ for the difference in flow rate δ. This problem is especially acute in conventional processes because multiple flow control devices, one for each precursor, must be controlled.

The inventors have determined that the use of dopant precursors which include both silicon and a dopant atom is highly effective in controlling the dopant concentration in glasses deposited by CVD, PECVD and FHD methods. Further, use of the new precursors results in a decrease in dopant clustering and dopant crystallite formation. Specifically, the inventors have determined that dopant concentration can be precisely controlled by using organometallic dopant precursors of the formula (R₃SiO)ⱼM(OR′)ₖ, where M is titanium or zirconium; R is an alkyl moiety; R′ is an alkyl moiety; j varies from 1 to 4; and k=4−j. Preferably R is methyl, ethyl or propyl while R′ is methyl, ethyl, n-propyl, isopropyl, n-butyl, isobutyl, t-butyl or s-butyl.

These dopant precursor compounds contain both the dopant atom and one to four silicon atoms. Thus, in certain cases (e.g., to make glasses with Si:M ratios of 1:1, 2:1, 3:1 and 4:1) only the dopant precursor is needed and there is need for only one precursor control device. For example, a glass layer deposited from tetrakis(trimethylsiloxy)titanium will have a Si:Ti ratio of about 4:1. Further, in cases requiring a non-stoichiometric ratio, the improved stability of these compounds allows them to be premixed with a silica precursor, such as tetraethylorthosilicate (TEOS), before admission to the deposition chamber. Because the dopant precursor includes both dopant and silicon atoms, the slope of the index versus dopant precursor concentration is lower than for a conventional dopant precursor such as a metal alkoxide. The amount of dopant relative to the amount of silicon in the growing layer for a given flow rate of dopant precursor is less than in conventional methods. Thus, for a delivery system with a given error in flow rate, the variation in the dopant concentration, and hence, the variation in index, will be less. Therefore, photonic devices having a smaller variation in index can be fabricated using the teachings of the present invention.

Thus, by using these compounds, the relative amounts of dopant and the silicon in the glass layer can be accurately and easily controlled. In addition, because M-O—Si bonds are already formed in the dopant precursor compound, the probability of the dopant clustering or crystallization of TiO₂ or ZrO₂ in the deposited glass is reduced.

In one embodiment of the invention, the organometallic dopant precursors are alkylsiloxides of titanium or zirconium having four alkylsiloxy groups (e.g. j=4 and k=0 in the formula above). These dopant precursors have a 4:1 ratio of silicon atoms to dopant metal atoms, and thus have a relatively low variation of index of refraction with dopant precursor flow rate. These compounds are useful in preparing films with Si:M ratios of about 4:1 or greater. A thin film of doped glass prepared by reacting solely a tetrakis(trialkylsiloxy)metal compound will have about a 4:1 Si:M ratio. Tetrakis(trimethylsiloxy)titanium and tetrakis(trimethylsiloxy)zirconium are preferred because of the stability of these compounds.

The tetrakis(alkylsiloxy)metals may be reacted with silica precursors to yield doped glass films with Si:M ratios of greater than 4:1. As the skilled artisan will appreciate, the Si:M ratio may be controlled by the identities and the flow rates of the precursors. Examples of silica precursors include, but are not limited to, tetraethoxysilane (TEOS), silane, disilane, tetramethylsilane, trimethylsilane, dimethylsilane, methylsilane, tetraaminosilane, triaminosilane, diaminosilane, aminosilane, tetrakis(diethylamino)silane, octamethylcyclotetrasiloxane (OMCTS), tetramethylcyclotetrasiloxane (TOMCATS) and di-acetoxydi-s-butoxysilane (DABS). Other precursors such as conventional phosporus precursors (e.g. trialkylphosphorus) and conventional boron precursors (e.g. trialkylboron) may be reacted with the silica precursors and dopant precursors to give desired glass compositions.

As noted above, it is possible to deposit films with Si:M ratios of 4:1 or greater with tetrakis(trialkylsiloxy)metal precursors. For some applications it is desirable to produce films with a Si:M ratio of lower than 4:1. Higher dopant concentrations may yield films with different desired properties. For example, films with higher titanium or zirconium concentrations will have higher refractive indices. Films with lower Si:M ratios may made using dopant precursors with lower Si:M ratios. For example, tris(trialkylsiloxy)alkoxymetal ((R₃SiO)₃M(OR′), Si:M=3:1), bis(trialkylsiloxy)bisalkoxymetal ((R₃SiO)₂M(OR′)₂, Si:M=2:1), or (trialkylsiloxy)trialkoxymetal ((R₃SiO)M(OR′)₃, Si:M=1:1) compounds may be used. These compounds may be made by replacing trialkylsiloxy groups of the tetrakis(trialkylsiloxy)metal compounds with alkoxy groups using conventional ligand exchange methods. Especially desirable dopant precursors include tris(trimethylsiloxy)isopropoxytitanium, tris(trimethylsiloxy)isopropoxyzirconium, bis(trimethylsiloxy)diisopropoxytitanium, bis(trimethylsiloxy)diisopropoxyzirconium, (trimethylsiloxy)triisopropoxytitanium, and (trimethylsiloxy)triisopropoxyzirconium.

As described above in connection with the tetrakis(trialkylsiloxy)metal compounds, these dopant precursors may be reacted with silica precursors to form films with non-stoichiometric Si:M ratios. For example, a film with a Si:M ratio of about 2.5:1 may be made using bis(trialkylsiloxy)bisalkoxymetal and tetraethylorthosilicate in about a 2:1 mole ratio. Further, the dopant precursors of the present invention may be combined to yield films with non-stochiometric Si:M ratios. For example, a film with a Si:M ratio of about 1.5:1 may be made using about a 1:1 mole ratio mixture of bis(trialkylsiloxy)dialkoxymetal and (trialkylsiloxy)trialkoxymetal. By judiciously combining dopant precursors, doped glass films with refractive indices at 1550 nm between about 1.44 and about 1.71 may be fabricated using the methods of the present invention. As the skilled artisan will appreciate, some tuning of the mole ratios of the precursors may be necessary to get the desired film composition. For example, in some cases, the stoichiometry of the precursor is not exactly reflected in the stoichiometry of doped glass film. The skilled artisan will be able to account for such behavior by changing the concentrations of the precursors.

As is shown in the examples given below, the dopant precursors of the present invention can be used advantageously in chemical vapor deposition processes such as plasma enhanced chemical vapor deposition (PECVD) processes as well as in flame hydrolysis deposition (FHD) processes to yield films suitable for use in photonic devices. As is appreciated by the skilled artisan, in PECVD processes, the dopant precursors and any other precursors are reacted at the substrate surface to form a homogeneous layer of doped silica on the surface of the substrate. In FHD processes, the dopant precursors and any other precursors are reacted in a flame to form a finely divided doped glass soot, which deposits on the surface of the substrate and is consolidated into a homogeneous glass in a subsequent heat treatment step. In both of these processes, the dopant precursor is said to be reacted to form a layer of doped silica on the surface of the substrate.

The methods of the present invention may be used to make thin film devices such as interference filters and antireflective coatings. The methods of the present invention may be combined with standard photolithographic techniques by the skilled artisan to fabricate planar waveguides with very well-controlled core and cladding refractive indices. The methods of the present invention may also be used by the skilled artisan to make an optical fiber preform, which may be drawn into an optical fiber using conventional methods.

### EXAMPLES

### Example I

TiO₂-doped silica glass films were deposited in a PECVD system using tetrakis(trimethylsiloxy)titanium (TTMST, R=Me, j=4, k=0, and M=Ti) and tetraethylorthosilicate (TEOS). The PECVD system was a parallel plate reactor wherein the precursor gases enter through an array of holes in the top electrode (showerhead), and the sample rests on the bottom electrode, a non-rotating heated platen. The chamber was pumped to approximately 500 mTorr pressure using a roots blower and rotary pump, and a plasma was formed using a 350 kHz RF power supply. Then, the vapors of TEOS and TTMST were introduced into the process chamber by conventional bubblers. Bubbler temperature was used to control the precursor flow rate from each bubbler. Oxygen was also introduced to the process chamber with a mass flow controller.

Four films with different ratios of TEOS and TTMST were deposited. The process parameters are shown in Table 1, while the elemental composition of the films is summarized in Table 2. Table 3 summarizes the refractive index measurements of the films.

TABLE 1

| Parameters | | 1A | 1B | 1C | 1D |
|---|---|---|---|---|---|
| Rf, 350 kHz | (W) | 300 | 300 | 300 | 300 |
| Substrate Temperature | (° C.) | 380 | 380 | 380 | 380 |
| Auxiliary Temperature | (° C.) | 110 | 110 | 110 | 110 |
| Pressure | (mTorr) | 600 | 600 | 600 | 600 |
| O₂ | (sccm) | 100 | 100 | 100 | 100 |
| N₂ thru TEOS | (sccm) | 5 | 0 | 5 | 5 |
| TEOS Temperature | (° C.) | 60 | 0 | 56 | 58 |
| TEOS Pressure | (torr) | 10.12 | 0 | 8.03 | 9.48 |
| N₂ thru TTMST | (sccm) | 0 | 5 | 5 | 5 |
| TTMST Temperature | (° C.) | 0 | 110 | 106 | 102 |
| TTMST Pressure | (torr) | 0 | 5.15 | 4.53 | 4.31 |
| Time | (min) | 30 | 30 | 30 | 30 |

TABLE 2

| Composition | | 1A | 1B | 1C | 1D |
|---|---|---|---|---|---|
| Si | (wt %) | 43.76 | 33.69 | 37.56 | 44.49 |
| Ti | (wt %) | 0.00 | 15.10 | 8.64 | 6.87 |
| O | (wt %) | 55.44 | 47.31 | 49.87 | 45.58 |
| C | (wt %) | 0.80 | 3.90 | 3.93 | 3.06 |
| TiO₂ | (mol %) | 0.01 | 20.81 | 11.88 | 8.3 |

TABLE 3

| Summary | n at 1550 nm | Thickness (μm) |
|---|---|---|
| 1A | 1.441 | 2.95 |
| 1B | 1.5157 | 5.12 |
| 1C | 1.4937 | 4.39 |
| 1D | 1.4754 | 4.2 |

By controlling the relative flow rates between the TEOS and TTMST bubblers, glass films over the refractive index range of 1.441 to 1.516 were produced (Table 3). It is also noted that the deposition rate of the TTMST deposited glass was over 10 μm/hr.

Table 2 shows that TiO₂-doped silica glass films can be deposited with a TiO₂ content varying from 0 to 20.8 mol % TiO₂ using TTMST as a dopant precursor. Table 2 also demonstrates that it is possible to deposit a film having the same stoichiometry as the precursor. This is clearly illustrated with sample 1B which was deposited using only TTMST as a precursor. The resulting film had a TiO₂ content of 20.8 mol %, within experimental error of the 4:1 stoichiometry of TTMST.

FIG. 1 illustrates an FTIR spectrum of film 1B. The spectrum shows that the as-deposited film has a relatively small OH content, some residual carbon in the form of Si—CH₃ and a large concentration of Si—O—Ti bonds. This demonstrates that using a precursor with Si—O—Ti bonds inhibits segregation of constituents, leading to a glass with a high degree of heterocondensation.

FIG. 2 demonstrates that using a precursor with Si—O—Ti bonds inhibits segregation of constituents. FIG. 2 is an XRD pattern of a 20 mol % TiO₂ film deposited using TTMST and annealed in air at 1000° C. for 18 h. Relative to prior art methods, remarkably little crystallization of anatase TiO₂ is observed.

### Example II

TiO₂-doped silicon-phosphorus-boron oxide glass films were deposited using FHD. In the FHD process, a fluid stream of premixed precursors is delivered to a burner using a conventional vaporizer. The precursors were hydrolyzed in a flame to form soot particles, which were deposited on a 10 cm diameter substrate. The soot was consolidated to yield a glass layer using methods familiar to the skilled artisan. The mole ratio of the components of the glass is determined by the mole ratio of the precursor mixture. The advantage of vaporizer delivery for FHD is that precise precursor mixtures can be made, leading to tighter composition control and improved index targets. It is also believed that the flame hydrolysis of a mixed cation precursor produces soot particles that are more homogeneous on delivery than might be achieved with a traditional precursor mix.

In this example, TTMST was used as the titanium dopant precursor. TTMST was selected due to its relatively slow hydrolysis rate compared to titanium ethoxides. OCTMS was used as a silica precursor, triethylborate was used as a boron precursor, and triethylphosphate was used as a phosphorus precursor. To avoid pre-hydrolysis of the TTMST, the other precursors were dried by reaction with a desiccating agent such as sodium ethoxide or phosphorus pentoxide.

Table 4 provides deposition parameters for FHD titanium-doped materials.

TABLE 4

| Parameters | | 2A | 2B | 2C |
|---|---|---|---|---|
| OMCTS | (wt %) | 35.8 | 48.6 | 48.6 |
| Triethylborate | (wt %) | 29.2 | 30.3 | 30.3 |
| Triethylphosphate | (wt %) | 9.4 | 9.9 | 9.9 |
| TTMST | (wt %) | 25.6 | 11.1 | 11.1 |
| Precursor Flow Rate | (ml/min.) | 0.06 | 0.06 | 0.06 |
| Vaporizer Temperature | (° C.) | 170 | 170 | 170 |
| Carrier Flow Rate | (sccm) | 1500 | 1500 | 1500 |
| # of Passes | | 650 | 240 | 326 |
| Soot Weight | (mg) | 82 | 96 | 120 |
| Soot Weight/Pass | (mg) | 0.126 | 0.4 | 0.37 |
| Thickness (after | (μm) | 4.9 | 5.6 | 6.0 |
| consolidation) | | | | |
| Index_{1550 nm}(after | | 1.467 | 1.4514 | 1.4516 |
| consolidation) | | | | |

TiO₂-doped silicon-boron-phosphorus oxide glass films with the desired composition were achieved. However, Sample 2A was processed prior to the development of the desiccation process, so the titanium yield was low due to hydrolysis in the precursor batch. Other deposition parameters were held constant over these samples. The results show that the targeted range of index values could be achieved, and that in successive samples (2B and 2C) good index and thickness uniformity could also be achieved.

### Example III

(Trimethylsiloxy)triisopropoxytitanium (TMSTIT) was prepared via ligand exchange by reacting titanium isopropoxide and tetrakis(trimethylsiloxy)titanium in a 3:1 molar ratio and heating at reflux. With this precursor, three films were deposited in a PECVD system. The deposition parameters are summarized in Table 5 below, while Tables 6 and 7 summarize the refractive indices of the three films and the elemental composition, respectively.

TABLE 5

| Parameters | | 3A | 3B | 3C |
|---|---|---|---|---|
| RF, 350 kHz | (W) | 300 | 400 | 300 |
| Substrate Temperature | (° C.) | 450 | 380 | 380 |
| Auxiliary Temperature | (° C.) | 110 | 110 | 110 |
| Pressure | (mTorr) | 600 | 600 | 600 |
| O₂ | (sccm) | 100 | 100 | 100 |
| N₂ thru TMSTIT | (sccm) | 5 | 5 | 5 |
| TMSTIT Temperature | (° C.) | 105 | 105 | 105 |
| TMSTIT Pressure | (Torr) | 20 | 20 | 20 |
| Time | (min) | 30 | 30 | 30 |

TABLE 6

| | | 3A | 3B | 3C |
|---|---|---|---|---|
| Index at 1550 nm | | 1.7037 | 1.5703 | 1.6149 |
| Thickness | (μm) | 4.19 | 1.5792 | 1.9893 |
| Growth Rate | (μm/h) | 12.57 | 6.32 | 7.96 |
| Stress | (MPa) | | −129.2 | −162.9 |

TABLE 7

| Composition | | 3A | 3B | 3C |
|---|---|---|---|---|
| Si | (wt %) | 13.25 | 30.29 | 23.79 |
| Ti | (wt %) | 15.28 | 4.19 | 9.76 |
| O | (wt %) | 65.73 | 69.20 | 67.35 |
| C | (wt %) | 5.75 | −3.68 | −0.90 |
| TiO₂ | (mol %) | 53.55 | 12.16 | 29.09 |

From the range of the refractive indices and the elemental compositions, it can be seen that both Si and Ti are being transported in the vapor phase. However, it appears that the TMSTIT is less stable than TTMST and thus, Si and Ti may not always deposit in a 1:1 ratio. The variation in the elemental composition of the resulting films can also be seen in the changing relative intensities of the Si—O—Si and Si—O—Ti bonds in the FTIR spectra in FIG. 3. It is likely that redistribution reactions occur between the isopropoxy and trimethylsiloxy groups, leading to the transport of several different species of various Ti:Si ratios. Nevertheless, the skilled artisan will recognize that precursors such as TMSTIT can be used to fabricate films with high refractive index with a reasonable amount of experimentation.

The foregoing description of the invention has been presented for purposes of illustration and description. It is not intended to be exhaustive or to limit the invention to the precise form disclosed, and modifications and variations are possible in light of the above teachings or may be acquired from practice of the invention. The figures and description were chosen in order to explain the principles of the invention and its practical application. It is intended that the scope of the invention be defined by the claims appended hereto, and their equivalents.

What is claimed is:

1. A method for growing a doped glass film on a surface of a substrate comprising the step of:
reacting a dopant precursor compound of the formula (R₃SiO)ⱼM(OR′)ₖ to deposit a doped glass film on the surface of the substrate;
wherein M is Ti or Zr; R is an alkyl moiety; R′ is an alkyl moiety; j is 1, 2, 3 or 4; and k=4−j.

2. The method of claim 1, wherein R is selected from the group consisting of methyl, ethyl and propyl; and R′ is selected from the group consisting of methyl, ethyl, n-propyl, isopropyl, n-butyl, isobutyl, t-butyl and s-butyl.

3. The method of claim 1, wherein the reacting step occurs at the surface of the substrate.

4. The method of claim 3, wherein the reacting step is performed using a CVD process.

5. The method of claim 3, wherein the CVD process is an inside vapor deposition process or an outside vapor deposition process.

6. The method of claim 5 wherein the reacting step is performed using a PECVD process.

7. The method of claim 3 wherein the doped glass film is substantially condensed upon deposition.

8. The method of claim 1, wherein the reacting step does not occur at the surface of the substrate.

9. The method of claim 8, wherein the reacting step is performed using a flame hydrolysis deposition process.

10. The method of claim 9 wherein the doped glass film deposited in the reacting step is a layer of doped glass soot particles, and wherein the method further comprises the step of consolidating the soot particles to a homogeneous doped glass film by heat treatment.

11. The method of claim 1 wherein a silica precursor is reacted with the dopant precursor.

12. The method of claim 11, wherein the silica forming substance is selected from the group consisting of tetraethoxysilane, silane, disilane, tetramethylsilane, trimethylsilane, dimethylsilane, methylsilane, tetraaminosilane, triaminosilane, diaminosilane, aminosilane, tetrakis(diethylamino)silane, octamethylcyclotetrasiloxane, tetramethylcyclotetrasiloxane and diacetoxydi-s-butoxysilane.

13. The method of claim 1, wherein the organometallic compound is chosen from the group consisting of tetrakis(trimethylsiloxy)titanium, tetrakis(trimethylsiloxy)zirconium, tris(trimethylsiloxy)isopropoxytitanium, tris(trimethylsiloxy)isopropoxyzirconium, bis(trimethylsiloxy)diisopropoxytitanium, bis(trimethylsiloxy)diisopropoxyzirconium, (trimethylsiloxy)triisopropoxytitanium, and (trimethylsiloxy)triisopropoxyzirconium.

14. A planar optical device comprising a substrate and a doped glass film made by a method comprising the step of:
reacting a dopant precursor compound of the formula (R₃SiO)ⱼM(OR′)ₖ to deposit a doped glass film on the surface of the substrate;
wherein M is Ti or Zr; R is an alkyl moiety; R′ is an alkyl moiety; j is 1, 2, 3 or 4; and k=4−j.

15. The planar optical device of claim 14, wherein the index of refraction of the film is between 1.44 and 1.71.

16. The planar optical device of claim 14 wherein the reacting step is performed using a CVD process.

17. The planar optical device of claim 14 wherein the reacting step is performed using a FHD process.

18. An optical fiber made by a method comprising the step of:
reacting a dopant precursor compound of the formula (R₃SiO)ⱼM(OR′)ₖ to deposit a doped glass film on the surface of a substrate;
wherein M is Ti or Zr; R is an alkyl moiety; R′ is an alkyl moiety; j is 1, 2, 3 or 4; and k=4−j.

19. The optical fiber of claim 18 wherein the index of refraction of the doped glass film is between 1.44 and 1.71.

20. The optical fiber of claim 18 wherein the reacting step is performed using a CVD process.

21. The optical fiber of claim 18 wherein the reacting step is performed using a FHD process.
